(19) United States
(12) Patent Application Publication
(10) Pub. No.: US 2014/0000523 A1
(43) Pub. Date: Jan. 2, 2014

(54) FEEDING SHEET AND METHOD OF FEEDING BABY BIRD

(71) Applicant: Takaaki Fujimoto, Ikeda-shi (JP)

(72) Inventor: Takaaki Fujimoto, Ikeda-shi (JP)

(73) Assignee: MF CO., LTD., Osaka-shi, Osaka (JP)

(21) Appl. No.: 14/005,788

(22) PCT Filed: Mar. 26, 2012
(86) PCT No.: PCT/JP2012/002081

§ 371 Date: Sep. 17, 2013

(30) Foreign Application Priority Data
Mar. 31, 2011 (JP) 2011-078084

(51) Int. Cl. A01K 39/01

(52) U.S. Cl. CPC A01K 39/01
USPC 119/57.91

(57) ABSTRACT

The purpose is to provide a feeding sheet and a method of feeding baby birds, from which suitable raising of the baby birds can be attained where the baby birds eat more food. The feeding sheet (1) according to the present invention is configured such that the color of the feeding sheet (1) to be installed on a floor (3) for raising baby birds (5) is made different from the color of food (2), and the method of feeding baby birds is configured such that the color of the feeding sheet (1) to be installed on the floor (3) in a raising area is made different from the color of the food for raising.

### TECHNICAL FIELD

The present invention relates to a feeding sheet used for feeding a “baby bird (also referred to as “chick” herein and in the claims)” in raising poultry such as chickens, and also relates to a method for feeding (raising) the baby birds.

### BACKGROUND ART

In poultry farming, for example, in farming of chickens such as for broilers, the growth of chickens thereafter will greatly depend on how much food the chickens ate and how much the chickens grew within a baby-bird stage, specifically, within about seven days after the entry of a feeding farm (which refers to that “the chickens are taken out of a brooding field and put into the feeding farm”). In other words, it is known that baby birds, which ate a lot of food during the period of about seven days after the feeding farm entry, grow promisingly thereafter.

Therefore, it is very important for poultry farmers to devise that baby birds eat a lot of food during the period of about seven days after the feeding farm entry.

In poultry houses, poultry farming has been conducted conventionally on a floor where material such as sawdust (wood shavings) is spread. In this case, for baby birds immediately after the feeding farm entry, they have a habit not to go to a feeding box to eat food, but to only eat food nearby on the floor even if the feeding box is installed.

However, if food is “spread” over the sawdust or the like, it is difficult for the baby birds to find the food mixed with the sawdust or the like. Therefore, it is hard for the baby birds to eat a necessary amount of food for their promising growth.

In addition, if the material such as sawdust is spread over the floor, it is necessary to periodically add the sawdust on the floor.

In consideration of such a situation, a method of raising baby birds is proposed in which, when the baby birds are raised, a paper sheet is installed over the floor surface instead of the sawdust and food is spread over the sheet to raise the baby birds (refer to Patent Document 1). In this case, since the food is always on the sheet and the food will not be buried into sawdust, it is easier for the baby birds to find the food.

When the sheet may be replaced with a new one, in such a case, the old sheet is simply removed and the new sheet is then installed. Thus, it is much less burdensome and a disposal of the used sheet is relatively easy, compared with the case of the conventional feeding method described above. In addition, it is said to be sanitary desirable for those baby birds which are still less tolerance to diseases.

### CONVENTIONAL ART REFERENCE

### Patent Document

Patent Document 1: JP2005-080593

### SUMMARY OF THE INVENTION

### Problem to be Solved by the Invention

However, it is found that baby birds do not eat food sufficiently even in a case where the paper sheet is installed on the floor and the food is spread over the sheet.

The present invention is made in view of such a situation, and its purpose is to provide a feeding sheet with which a baby bird eats more, and a method for feeding (raising) the baby bird.

### Means for Solving the Problem

A feeding sheet according to the present invention is a sheet to be installed on a floor of a poultry house in raising of a baby bird, the color of the feeding sheet is configured to be different from the color of food.

A method of feeding a baby bird according to the present invention is a method for feeding the baby bird by spreading food over a feeding sheet installed on a floor in a raising area, the feeding being conducted with the color of the feeding sheet being different from the color of the food to be used in raising.

The present inventor had doubts that, even if the baby birds are raised on the conventional installed paper sheet, the baby birds do not eat enough food which is spread over the paper sheet. For this reason, the inventor observed relations between the colors of the sheet and ingestion amounts of the food for a predetermined period of time, while changing the color of the paper sheet variously. Then, it is found that baby bird immediately after the feeding farm entry eat well if the color of the feeding sheet has a different color from the color of the food, particularly, a color which is different in the brightness in the Munsell color system by “2” or more. According to the inventor's presumption, visions and the like of baby birds immediately after the feeding farm entry may not be developed enough compared with mature birds (chickens) and, thus, they may be difficult to visually recognize the food if the colors of the food and the feeding sheet are identical or do not have much difference. Particularly, it is confirmed that, when there is the difference as described above in the brightness between the color of the food and the color of the feeding sheet, the baby birds eat well and moves more actively compared with the conventional sheet or method. In addition, when there is the difference as described above in the brightness between the color of the food and the color of the feeding sheet, if a raiser (worker) spreads the food over the sheet, the raiser can easily recognize visually the locations of the spread food. Therefore, they can spread the food uniformly as much as possible throughout the sheet. That is, ununiformity cannot be caused in the spreading the food. For this reason, for baby birds at respective locations on the sheet, there is substantially the same amount of the food near each baby birds at the locations. This increases ingestion amounts of the food by the respective baby birds which moves in a narrow area, and reduces a death rate of the baby birds caused by lack of the food.

In the feeding sheet, the brightness of the feeding sheet may preferably be lower by “2” or more in the Munsell color system than the brightness of the food. It is especially found that, when the brightness of the feeding sheet is lower by “2” or more in the Munsell color system than the brightness of the food, and when the feeding sheet is black or dark gray (particularly, black or gray which falls in 1 to 4 in the brightness of the Munsell color system), considerable raising results with the ingestion amount of the food being large can be obtained. Probably, since there is the color difference between the food and the sheet, it gives mental comfortableness to the baby birds, in addition to the reason of “easy recognition of the food” as described above, if the background color is black or dark gray based on the same reason that baby birds prefer shades.

In addition, when the sheet is black or dark gray, since the baby birds are easily noticeable, the raiser is easy to recognize activities of the baby birds. Therefore, weaken baby birds can easily be found and isolated therefrom. For this reason, it is desirable for the reduction in the death rate of the baby birds and prevention in infection of diseases.

In the feeding method, it is found that, when the color of the feeding sheet is black or dark gray, the baby birds eat a large amount of food. Probably, if the background color is black or dark gray, it gives mental comfortableness to the baby birds, in addition to the reason as described above, based on the same reason that baby birds prefer shades.

In addition, as for the feeding sheet, it is desirably made of material such that the feeding sheet is collapsed into tiny pieces after a predetermined period of time (i.e., after the sheet reaches a duration of service) by the baby birds stepping on the sheet or the sheet absorbing excreta or the like, or both.

Such a feeding sheet may have a configuration which is ecologically desirable for recycling if it is made of recycle paper.

### Effects of the Invention

According to the feeding sheet and the method of feeding baby birds according to the present invention constructed as described above, simply by selecting the particular color range from known colors of the paper sheet to use it for the feeding sheet, in other words, only using the paper sheet of the particular color for the “application” which is the “field of feeding baby birds,” the considerable effect which could not be obtained conventionally, i.e., a considerable increase in the ingestion amount of the food by the baby birds and efficient and stable raising, can be attained.

### BRIEF DESCRIPTION OF DRAWINGS

FIG. 1 is a perspective view schematically showing a raising state on a feeding sheet according to the present invention.

FIG. 2 is a partial cross-sectional view schematically showing a state of the feeding sheet shown in FIG. 1, and food spread over the sheet and a floor under the feeding sheet.

FIG. 3 is a perspective view showing a raising state where food is spread over a feeding sheet of a conventional color which is different from that in FIG. 1.

FIG. 4 is a table showing a difference in ingestion amounts of baby birds between a case where the feeding sheet according to one embodiment of the invention shown in FIG. 1 is used and a case where a conventional paper sheet shown in FIG. 3 is used.

FIG. 5 is a table according to one embodiment different from FIG. 4, showing a difference in growths of baby birds using their weights as a parameter between a case where the feeding sheet according to one embodiment of the invention shown in FIG. 1 is used and a case where a conventional paper sheet shown in FIG. 3 is used.

FIG. 6 is a graph and a table according to one embodiment different from FIGS. 4 and 5, showing a difference in growths of baby birds using their weights as s parameter between a case where the feeding sheet according to one embodiment of the invention shown in FIG. 1 is used and a case where a conventional paper sheet shown in FIG. 3 is used, where FIG. 6(a) is a graph having a vertical axis as percentage and a horizontal axis as the number of days, and FIG. 6(b) is a table showing a change in weight of the baby birds between a feeding farm entry and a week thereafter, as same as FIG. 5.

### MODE FOR CARRYING OUT THE INVENTION

Hereinafter, a feeding sheet and a method of feeding a baby bird according to one embodiment of the present invention are described with reference to the drawings, data of raising results (increase in weight of the baby birds), etc.

### Embodiment

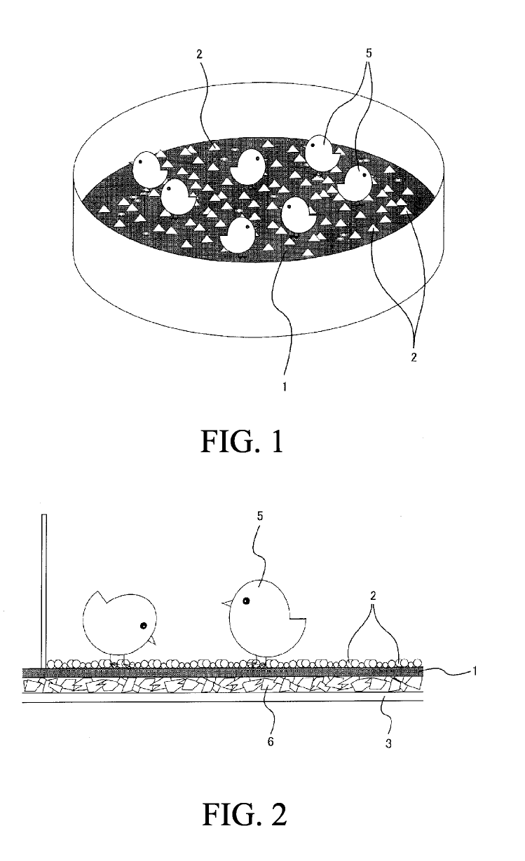

FIG. 1 shows a state where a feeding sheet 1 according to this embodiment is used, food 2 is spread thereon, and baby birds after a feeding farm entry is raised.

The feeding sheet 1 is made of recycled paper, and has color in black (or dark gray) with a brightness of about 3 in the Munsell color system. Note that FIG. 1 is a schematic view, and the baby birds are actually raised using a larger space than it is illustrated in a poultry house.

The feeding sheet 1 has extremely small spaces inside its structure where the fiber structures of paper are relatively short so that it is configured to easily absorb excreta and the like. In addition, the feeding sheet 1 has paper characteristics such that the feeding sheet 1 lies in fragments after a predetermined period of time (e.g., about four days to one week) when the baby birds step on the feeding sheet 1 from above. That is, the feeding sheet 1 uses material having paper characteristics such that the fiber structures of the paper are “coarse” and the material contains less binding agent (glue) which joins the fiber structures.

On the other hand, in this embodiment, the food 2 is of a type which is, in a quality sense, used generally for raising baby birds, and, in a color sense (particularly, brightness of the color), has a color with brightness of about 6 in the Munsell color system.

As described above, the feeding sheet 1 uses a color which is different from the color of the food 2. In other words, in the case of this embodiment, the feeding sheet 1 is used having a different “brightness” which is one of components of the color, among the color, from the food 2. Specifically, the feeding sheet 1 is used having a brightness which is about “3” different from the food 2 in the Munsell color system. However, the difference in the brightness may be “2” or more different in the Munsell color system.

Meanwhile, in order to form the feeding sheet 1 of about 3 in the brightness as described above, charcoal is used as a coloring agent and edible glue is used as the binding agent in this embodiment. However, in the present invention, the coloring agent is not limited to charcoal, and the feeding sheet 1 may be colored with other coloring agent(s) as long as the coloring agent has that brightness. For the binding agent, it is not limited to the edible glue. Alternatively, the feeding sheet 1 may be without any binding agents.

Further, as illustrated in FIG. 2, the feeding sheet 1 as described above is installed on sawdust 6 (alternatively, it may be cut straws or rice husks, as shown in FIG. 2) which is spread over a floor 3 so that the sawdust 6 has a substantially uniform thickness. The food 2 is spread over the feeding sheet 1 and the baby birds 5 are raised thereon.

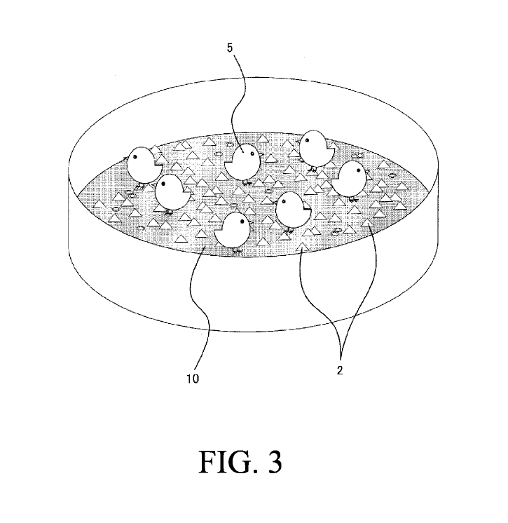

Thus, when the baby birds are raised using the feeding sheet 1, an ingestion amount of the food (weight) is considerably increased, compared with the case where the baby birds 5 are raised using a conventional paper sheet 10 shown in FIG. 3 which is commercially available. Therefore, a desirable growth can be obtained in raising thereafter.

In addition, the feeding sheet 1 having the paper characteristics as described above is, as it is used for about one week, fragmentally collapsed in a state where excreta and the like is excreted on and absorbed into the feeding sheet 1, by the baby birds and the like stepping on the feeding sheet 1.

The collapsed feeding sheet 1 will then be in a state where it is mixed into the sawdust 6 and the like described above.

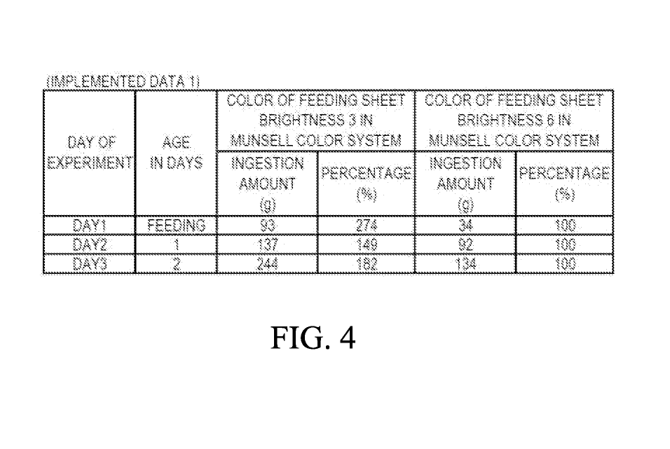

Meanwhile, in order to examine the effects of the feeding sheet 1 according to this embodiment described above, food ingestion amounts of the baby birds 5 which are raised on the sheet after the feeding farm entry are measured respectively in the case where the paper sheet 10 (see FIG. 3) which is described in Patent Document 1 described above and used conventionally is used and the case where the feeding sheet 1 according to this embodiment is used. The ingestion amounts are as follows. Note that, as for the conventional paper sheet 10 used for examining the effects, one which is commercially and conventionally available, and has in the color sense, in this example, a color of about 5 to 6 in brightness in the Munsell color system (described as “6” in brightness in the table of FIG. 4), is used.

As the results, as illustrated as the table in FIG. 4, at “first day” of feeding, in the case where the feeding sheet 1 according to this embodiment is installed and feeding is carried out, an average food ingestion amount by the baby birds 5 in a group (20 birds: only 7 are indicated in FIG. 1) was about 93 g. Contrary, in the case where the conventional paper sheet 10 is used, an average ingestion amount of the food by the baby birds 5 in a group (20 birds: only 7 are indicated in FIG. 3) was about 34 g.

Similarly, at “second day” of feeding, in the case where the feeding sheet 1 according to this embodiment is installed and feeding is carried out, the food ingestion amount of the same baby birds 5 was about 137 g. Contrary, in the case where the conventional paper sheet 10 is used, the food ingestion amount of the same baby birds 5 was about 92 g.

Similarly, at “third day” of feeding, in the case where the feeding sheet 1 according to this embodiment is installed and feeding is carried out, the food ingestion amount of the same baby birds 5 was about 244 g. Contrary, in the case where the conventional paper sheet 10 is used, the food ingestion amount of the same baby birds 5 was about 134 g.

Note that the “ratio” in the table of FIG. 4 indicates a ratio of the ingestion amount in the case where the sheet 1 according to the embodiment of the present invention when the ingestion amount of the baby birds in the case where the conventional paper sheet which has been commercially available was used is 100. That is, when the feeding sheet 1 according to this embodiment was used, it is found that the ingestion amount was about 1.5 to 3 times higher than the case where the conventional paper sheet 10 was used.

See the table of FIG. 4 for these effects.

Further, using the feeding sheet 1 described above and the conventional sheet 10 described in Patent Document 1, a raising experiment was conducted in a local poultry farm which is located at a region (specifically, in a poultry farm located in Kyushu region) different from the region (Tohoku region, Japan) used for obtaining the “Implemented Data 1” described above. The experiments were conducted in two poultry houses in the same poultry farm located in Kyushu region, where the duration of sunshine, temperature conditions, etc. are substantially the same, using respective baby birds hatched from a parent bird group having substantially the same extent, in the same raising conditions, over a period from a feeding farm entry (0W) to one week (1W). Note that the feeding sheet 1 and the conventional sheet 10 were respectively used only for first three days after the feeding farm entry, and, thereafter, the raising was conducted on the floor with sawdust.

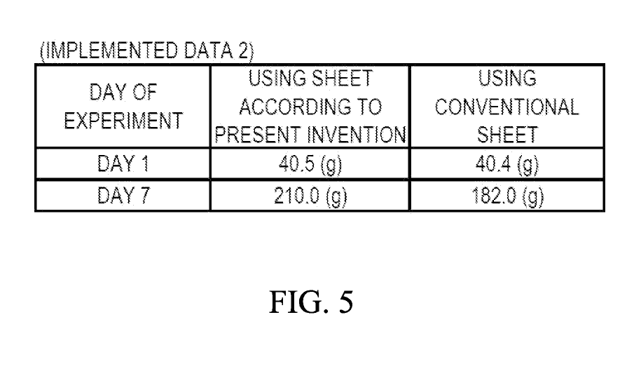

As shown in “Implemented Data 2” of FIG. 5, an average value of weights of the baby birds when raised using the feeding sheet 1 at the time of the feeding farm entry was 40.5 g, and, contrary, an average value of weights of the baby birds when raised using the sheet 10 was 40.4 g.

After that, as raised for one week (seven days) as described above, the average value of weights of the baby birds with the feeding sheet 1 being used was 210.0 g, and, contrary, the average value of weights of the baby birds with the sheet 10 being used was 182.0 g. Also from these data, it is found that the rate of growth was higher by 15.4% for the raising using the feeding sheet 1, as described above, even if the raising is conducted with substantially the same conditions except for the sheets.

Further, using the feeding sheet 1 and the conventional sheet 10 described in Patent Document 1, raising experiments were conducted in a local poultry farm which is located at a region (specifically, in a poultry farm located in Chugoku region) different from the regions used for obtaining the “Implemented Data 1” and “Implemented Data 2” described above. The experiments were conducted in two poultry houses in the same poultry house which are located adjacent to each other and have substantially the same duration of sunshine, temperature conditions, etc., using respective baby birds hatched from a parent bird group having substantially the same extent, in the same raising conditions, over a period from a feeding farm entry (0W) to one week (1W). Note that the feeding sheet 1 and the conventional sheet 10 were respectively used only for five days after the feeding farm entry, and, thereafter, the raising was conducted on the floor with sawdust.

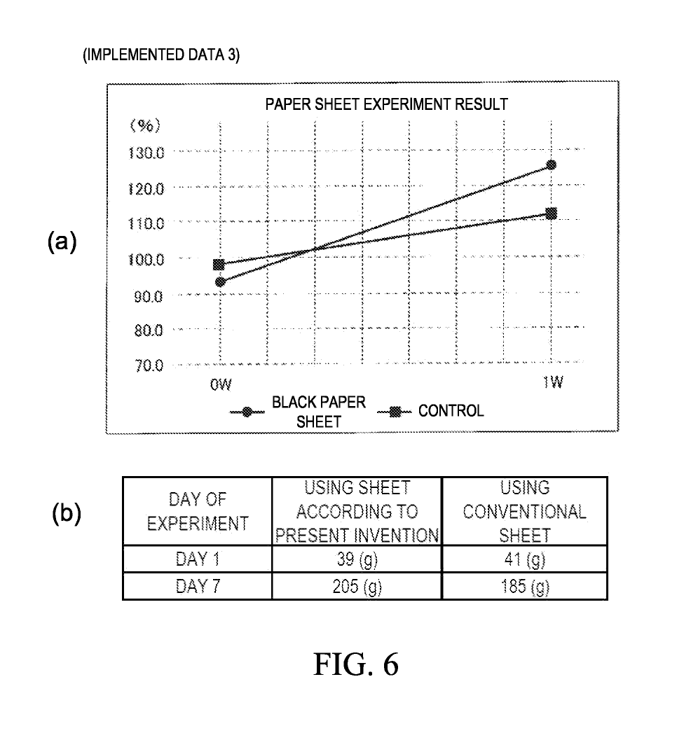

As shown in “Implemented Data 3” of FIG. 6(a), an average value of weights of the baby birds when raised using the feeding sheet 1 at the time of the feeding farm entry was about 93 when a value of standard baby birds is 100, and, contrary, an average value of weights of the baby birds when raised using the sheet 10 was about 98 when a value of standard baby birds is 100.

After that, as raised for one week (seven days) as described above, the average value of weights of the baby birds with the feeding sheet 1 being used was about 126 when a value of standard baby birds is 100, and, contrary, the average value of weights of the baby birds with the sheet 10 being used was about 112 when a value of standard baby birds is 100. Also from these data, it is found that the rate of growth was higher by 12.5% for the raising using the feeding sheet 1, as described above, even if the raising is conducted with substantially the same conditions except for the sheets. If the effects shown in “Implemented Data 3” are represented by increases in the weights of the baby birds, an average value of weights of the baby birds when raised using the feeding sheet 1 at the time of the feeding farm entry was 39 g, and, contrary, an average value of weights of the baby birds when raised using the sheet 10 was 41 g, as shown in FIG. 6(b).

After that, as raised for one week (seven days), the average value of weights of the baby birds with the feeding sheet 1 being used was 205 g, and, contrary, the average value of weights of the baby birds with the sheet 10 being used was 185 g.

Although not shown in this “Implemented Data 3,” even after one week, an observation was made for the raising state up to six weeks after the feeding farm entry (6W) by comparing “weights” as a parameter. It is found that the growth of the baby birds with the feeding sheet 1 being used for the first five days was better than the growth of the baby birds with the conventional sheet 10 being used. In addition, it is found that the former was higher in their growth level compared with the reference value (100). This result supports that eating more food during the period from the feeding farm entry up to about seventh day as described above is important for the baby birds in order for the growth thereafter and a reduction in death rate of the baby birds.

Note that, although the feeding farm entry was made two days earlier for the poultry house using the conventional sheet 10 than the poultry house using the feeding sheet 1, the observation was conducted, in order to obtain accurate data, starting from a reference timing (“0W”) which is the feeding house entry, respectively.

Meanwhile, in FIG. 6(a), the value on the vertical axis is percentage, and weights of the baby birds (average weights) at respective time points are indicated in percentage with standard weights of baby birds at the same respective time points being 100%.

Meanwhile, in the embodiment described above, although the feeding sheet 1 having a brightness of about 3 in the Munsell color system was used, similar or more effects can possibly be obtained if lower brightness (closer to black) is used.

If the brightness of the food 2 is higher than the brightness of about 6 as described above, the feeding sheet 1 having a “higher” brightness can also be used, and, on the other hand, if the brightness of the food 2 is even lower than the above, the feeding sheet 1 having a “lower” brightness can also be used.

Further, because the feeding sheet 1 will be collapsed as described above after being used for the predetermined period of time, burden such as removal and disposal of the conventional paper sheet 10 can be eliminated. That is, because, for the feeding sheet according to this embodiment, it is collapsed and mixed with the sawdust 6, it is not necessary to dispose particularly after its use. Therefore, for poultry farmers, the burden of disposal can be eliminated and the cost of disposal can be unnecessary. In addition, a space for temporarily storing the used feeding sheet 1 before disposal will be unnecessary.

Particularly, like this embodiment, the feeding sheet 1 is desirable if the coloring of the sheet is made with material which is harmless for the baby birds 5 such as charcoal and if the edible glue is used as the binding agent (glue) for joining the fiber structures of the paper, because the feeding sheet 1 will be harmless even if the baby birds eat the sheet.

Meanwhile, for the implemented data, raising was carried out using the feeding sheet for about three to five days after the feeding house entry. However, even when the feeding sheet was used for about three days after the feeding house entry, the effects inherent to the present invention were obtained unlike the case where the conventional sheet was used or no sheet was used.

In addition, after five days from the feeding house entry, if raising is carried out using the feeding sheet, it is inferred that the increase in weights of the baby birds is expected more than the case where the conventional sheet is used or no sheet is used.

Further, according to the feeding sheet and the method of feeding baby birds according to the present invention, as shown in FIGS. 4 to 6, since the period of time for the baby birds to reach their weight to be shipped can be shortened, the shipping becomes earlier. For this reason, by accelerating the shipment, profitability can be improved.

Meanwhile, the embodiment described above is merely one embodiment of the present invention; however, it is needless to say that the present invention is not limited to the embodiment and it can be implemented in various forms within the scope based upon the technical ideas of the present invention.

### Industrial Applicability

The feeding sheet and the method of feeding baby birds according to the present invention can be utilized in the fields of poultry farming, etc.

### DESCRIPTION OF REFERENCE NUMERALS

1 Feeding Sheet

2 Food

3 Floor

5 Baby Bird

10 Conventional Paper Sheet

1-6. (canceled)

7. A method for feeding baby birds by spreading food over a feeding sheet installed on a floor in a raising area, comprising the steps of:
installing a paper feeding sheet on a material spread over the floor, the material including sawdust, cut straw, or rice husks; and
feeding the baby birds.

8. The method for feeding baby birds according to claim 7, wherein, as the paper feeding sheet, a feeding sheet different to a brightness of the food by “2” or more in the Munsell color system is used, and the material is at least one selected from the group consisting of sawdust, cut straw, and rice husks.

9. A method for feeding baby birds, comprising the steps of:
spreading at least one material selected from the group consisting of sawdust, cut straws, and rice husks over a floor in a raising area;
installing a paper feeding sheet over the material; and
spreading food over the feeding sheet,
wherein the feeding sheet is a sheet different to a brightness of the food by “2” or more in the Munsell color system, and is made of paper with coarse fiber structures, and
wherein the feeding sheet installed on the material lies in fragments after four days to one week by the baby birds stepping on the feeding sheet when feeding.

10. A feeding sheet for baby birds, wherein the feeding sheet is to be used in a method for feeding baby birds by installing a feeding sheet on a floor in a raising area and spreading food over the feeding sheet, wherein the feeding sheet is made of paper with coarse fiber structures so that the feeding sheet lies in fragments after four days to one week by the baby birds stepping on the feeding sheet when feeding.

11. The feeding sheet for baby birds according to claim 10, wherein the feeding sheet for baby birds is installed on the material including sawdust, cut straws, or rice husks spread over the floor in a raising area, and the feeding sheet is different to a brightness of the food by “2” or more in the Munsell color system.

12. The feeding sheet according to claim 10, wherein the color of the feeding sheet for baby birds is black or dark gray, and charcoal is used as a coloring agent for the color of black or dark gray.

13. The feeding sheet according to claim 11, wherein the color of the feeding sheet for baby birds is black or dark gray, and charcoal is used as a coloring agent for the color of black or dark gray.
